(19) United States
(12) Patent Application Publication
(10) Pub. No.: US 2025/0323292 A1
(43) Pub. Date: Oct. 16, 2025

(54) PASSIVE CARBON-OXYGEN BATTERY SYSTEM AND METHOD OF USE THEREOF

(71) Applicant: Form Energy, Inc., Somerville, MA (US)

(72) Inventors: Joseph S. Manser, Reading, MA (US); Christopher Thomas Reynolds, Arlington, MA (US); Liang Su, Somerville, MA (US); Nicholas Perkins, Emeryville, CA (US)

(21) Appl. No.: 19/175,148

(22) Filed: Apr. 10, 2025

Related U.S. Application Data
(60) Provisional application No. 63/632,412, filed on Apr. 10, 2024.

(51) Int. Cl. H01M 8/04082; H01M 8/04007; H01M 8/0668; H01M 8/1246; H01M 8/14; H01M 12/08

(52) U.S. Cl. CPC H01M 8/04216; H01M 8/04067; H01M 8/0668; H01M 8/1246; H01M 8/146; H01M 12/08

(57) ABSTRACT

A carbon-oxygen battery system, including a Boudouard reactor in fluid communication with an electrochemical cell; a carbon store configured to store carbon; a gas store in fluid communication with the electrochemical cell, and a fuel gauge. The gas store is configured to separately store oxygen and a carbon-containing gas, wherein the gas store comprises a movable barrier separating the oxygen from the carbon-containing gas. The fuel gauge configured to determine a state of charge based on a position of the movable barrier, a mass of the oxygen in the gas store, a mass of the carbon-containing gas in the gas store, a mass of carbon in the carbon store, a volume of carbon in the carbon store, or a combination thereof. The gas store and the electrochemical cell form a closed system.

### CROSS REFERENCE TO RELATED APPLICATION

This application claims priority to and the benefit of U.S. Provisional Patent Application No. 63/632,412, filed Apr. 10, 2024, in the United States Patent and Trademark Office, the content of which in its entirety is hereby incorporated by reference.

### BACKGROUND

This disclosure relates to a carbon-oxygen battery system, a battery fuel gauge, and a method of operating a carbon-oxygen battery system with the fuel gauge.

Rechargeable batteries are electrochemical devices that can deliver electricity on discharge and can be charged to store electricity. Rechargeable batteries help solve the problem of discontinuous production of electrical energy and allow for storing electrical energy when the electricity supply does not match the electricity demand.

Carbon-oxygen rechargeable batteries are a promising technology for energy storage. Carbon-oxygen batteries leverage low-cost materials (e.g., carbon dioxide, carbon monoxide, carbon, and oxygen from ambient air) to reversibly store energy. There remains a continuing need for an improved carbon-oxygen battery system. It can further be advantageous to accurately estimate the energy stored in a rechargeable battery.

### SUMMARY

A carbon-oxygen battery system, comprising: an electrochemical cell, a Boudouard reactor in fluid communication with the electrochemical cell; a carbon store configured to store carbon; and a gas store in fluid communication with the electrochemical cell, the gas store configured to separately store oxygen and a carbon-containing gas, wherein the gas store comprises a movable barrier separating the oxygen from the carbon-containing gas; and a fuel gauge configured to determine a state of charge based on a position of the movable barrier, a mass of the oxygen in the gas store, a mass of the carbon-containing gas in the gas store, a mass of carbon in the carbon store, a volume of carbon in the carbon store, or a combination thereof, wherein the gas store and the electrochemical cell form a closed system.

A battery fuel gauge configured to determine a state of charge of a carbon-oxygen battery, wherein the battery fuel gauge comprises a processor configured to receive information relating to a position of a movable barrier of a gas store, a mass of oxygen in the gas store, a mass of a carbon-containing gas in the gas store, or a combination thereof and to determine the state of charge based on the position of the movable barrier, the mass of the oxygen in the gas store, the mass of the carbon-containing gas in the gas store, or a combination thereof; wherein the carbon-oxygen battery comprises: an electrochemical cell, a carbon store, a Boudouard reactor in fluid communication with the electrochemical cell and the carbon store, and the gas store; wherein the gas store is configured to separately store the oxygen and the carbon-containing gas, wherein the gas store comprises the movable barrier separating the oxygen from the carbon-containing gas, wherein the gas store and the electrochemical cell form a closed system.

A battery fuel gauge configured to determine a state of charge of a carbon-oxygen battery, wherein the battery fuel gauge comprises a processor configured to receive information relating to a mass of carbon in a carbon store, a volume of carbon in the carbon store, or a combination thereof and to determine the state of charge based on the mass of carbon in the carbon store, the volume of carbon in the carbon store, or a combination thereof; wherein the carbon-oxygen battery comprises an electrochemical cell, a carbon store, and a Boudouard reactor in fluid communication with the electrochemical cell and the carbon store.

A method of operating a carbon-oxygen battery system, the method comprising: providing a carbon-oxygen battery system, wherein the carbon-oxygen battery system comprises an electrochemical cell, a Boudouard reactor in fluid communication with the electrochemical cell, a carbon store configured to store carbon, and a gas store in fluid communication with the electrochemical cell; charging the carbon-oxygen battery system by supplying electricity to the carbon-oxygen battery system, supplying a carbon-containing gas to the electrochemical cell, wherein the carbon-containing gas comprises carbon dioxide and is provided by the gas store, converting the carbon dioxide to carbon monoxide and oxygen in the electrochemical cell, converting the carbon monoxide to carbon dioxide and carbon in the Boudouard reactor, storing the carbon produced by the charging in the carbon store; and storing the oxygen produced by charging in the gas store, and discharging the carbon-oxygen battery system to produce electricity by converting the carbon and carbon dioxide in the Boudouard reactor to carbon monoxide, supplying an oxygen gas flow to the electrochemical cell, wherein the oxygen gas flow is provided by the gas store, converting the carbon monoxide and oxygen to carbon dioxide by the electrochemical cell, and storing the carbon dioxide produced by the discharging in the gas store.

The above and other aspects and features are described and exemplified by the following figures and detailed description.

### BRIEF DESCRIPTION OF THE DRAWINGS

The following figures are exemplary embodiments wherein like elements are numbered alike.

FIG. 1 is a schematic diagram illustrating a carbon-oxygen battery system according to one or more aspects when the electrochemical cell is in a charged state;

FIG. 2 is a schematic diagram illustrating a carbon-oxygen battery system according to one or more aspects when the electrochemical cell is in a discharged state;

FIG. 3 is a schematic diagram illustrating a carbon-oxygen battery system according to one or more aspects;

FIG. 4 is a schematic diagram illustrating a carbon-oxygen battery system according to one or more aspects;

FIG. 5 is a schematic diagram illustrating an electrochemical cell according to one or more aspects;

FIG. 6 is a schematic diagram illustrating a carbon-oxygen battery system according to one or more aspects; and

FIG. 7 is a schematic diagram illustrating a carbon-oxygen battery system according to one or more aspects.

### DETAILED DESCRIPTION

Determining a state-of-charge of an air battery, also known as fuel gauging, is a non-trivial function of energy storage systems that have a limited energy storage capacity. For example, when determining a remaining range of an electric vehicle or a remaining run time for a stationary storage system supporting an electricity grid or in a behind-the-meter application, accurate measurement of the energy remaining in the system is preferred.

The present disclosure involves the estimation of the state-of-charge for rechargeable carbon-oxygen electrochemical energy storage systems that operate as flow batteries or reversible fuel cell systems. These systems store electrochemical reactants separately from the source of power generation and consumption, where power generation corresponds with discharge mode and power consumption corresponds with charge mode. This is advantageous because it allows independent scaling of energy and power, which provides enhanced flexibility in meeting application-specific requirements for energy storage systems.

Energy storage systems with decoupled energy and power, e.g., in which electrochemical reactants and products are stored separately from the electrode surfaces and in which the concentration of reactants entering the stack and pressure of operation within the stack are relatively constant, cannot readily rely on electrochemical measurements such as voltage, resistance, or derivative quantities of these factors, to estimate the state-of-charge. In such systems, the electrochemical potential and electronic and mass transport properties at the positive and negative electrodes remain relatively constant as the energy storage medium is depleted and replenished. Therefore, there remains a need for alternative methods for fuel gauging in flow batteries or reversible fuel cell systems.

The disclosure provides non-electrochemical methods for fuel gauging in carbon-oxygen batteries. Fuel gauging methods may be combined, e.g., for redundancy or to improve accuracy.

In an aspect, disclosed herein is a carbon-oxygen battery system that is configured to estimate the energy remaining in the battery system via non-electrochemical methods.

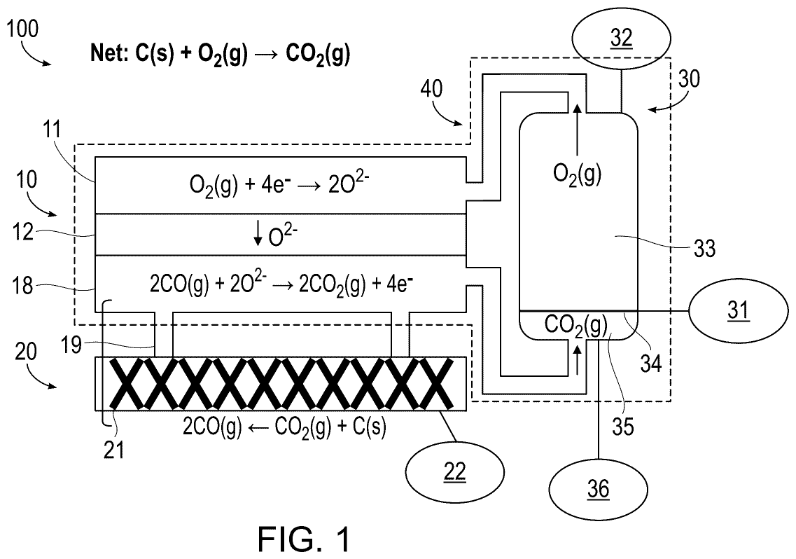

Referring to FIGS. 1 to 4, and 6 to 7, a carbon-oxygen battery system 100 comprises a Boudouard reactor 20 in fluid communication with an electrochemical cell 10, which includes a positive electrode 11, negative electrode 18, and an electrolyte 12 disposed between the positive and negative electrodes.

The electrochemical cell can be a solid oxide cell, which uses a solid-state oxygen-anion (O²⁻) conducting electrolyte. The electrochemical cell can also be a molten carbonate cell, which uses a carbonate anion (CO₃²⁻) conducting electrolyte. Other types or combinations of cell types may be used for the electrochemical cell. Individual cells can be assembled into multi-cell components to meet power or other requirements. This group of cells is often referred to as a power stack or simply a stack.

The electrochemical cell 10 can convert CO₂ to CO and O₂ on charge, or CO and O₂ to CO₂ on discharge as shown in equation (1):

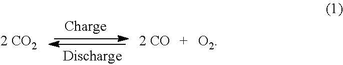

The Boudouard reactor 20 converts CO to CO₂ and C on charge, or provides CO from CO₂ and C on discharge as shown in equation (2):

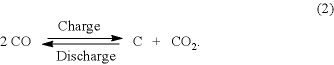

The reaction is a catalytic reaction, known as the Boudouard reaction.

The net reaction for the carbon-oxygen battery system is provided in equation (3):

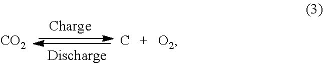

wherein the reaction proceeds to the right on charge and to the left on discharge. Due to their high energy density and high theoretical round-trip efficiency, carbon-oxygen battery systems are desirable for stationary storage applications. The Boudouard reaction leads to the formation of solid carbon.

It is noted that the solid carbon may be in any form and can include, for example, particles, needles, plates, slabs, granules, rods, wires, filaments, and the like, or a combination thereof. The carbon may be pure elemental carbon or may comprise impurities. The carbon may be crystalline or amorphous. The carbon may be graphitic.

The Boudouard reactor 20 can be configured to function as a carbon store 21.

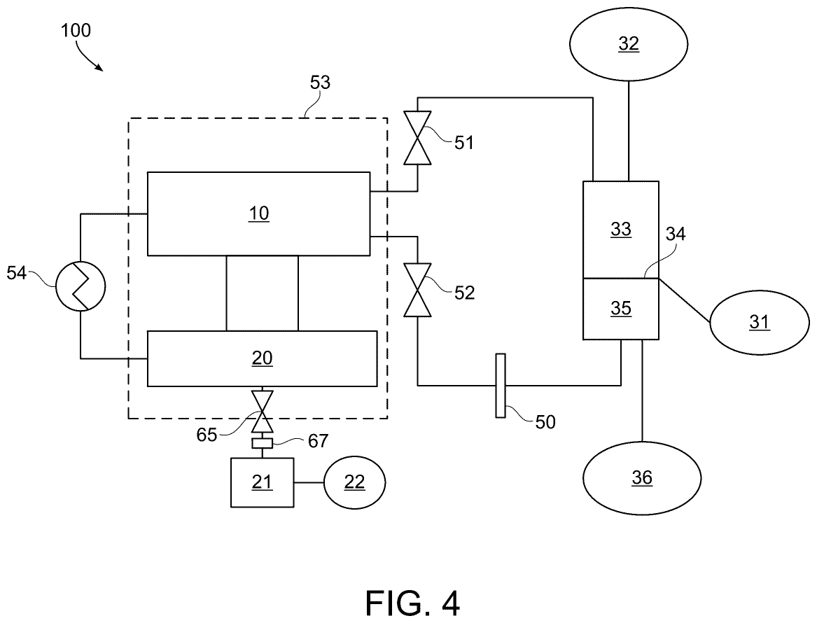

Thus, the carbon store 21 may be disposed inside the Boudouard reactor 20 (as shown in FIGS. 1 to 3 and 6 to 7). Alternatively, the carbon-oxygen battery system 100 can comprise a carbon store 21 disposed outside of the Boudouard reactor 20 and in communication with the Boudouard reactor 20 (as shown in FIG. 4). In such a configuration, the carbon-oxygen battery system can further comprise a conveyance member 67 to convey carbon source material between the Boudouard reactor and the carbon store. Representative conveyance members can include, for example, a belt conveyor, a screw feed, a vacuum conveyor, a gravitation feed, a pneumatic conveyor, or a vibrating conveyor. The conveyance of carbon material between the Boudouard reactor and the carbon source may be accomplished by transport manually, through a vehicle, a robot, or through various combinations and permutations thereof. In an aspect, the Boudouard reactor 20 can be configured to be selectively isolated from the carbon store 21. For example, a carbon source supply valve 65 may be used to isolate the Boudouard reactor 20 from the carbon store 21 (as shown in FIG. 4).

The Boudouard reactor 20 may be configured to be selectively isolated from the carbon-oxygen battery system, for example to repair or replace the Boudouard reactor 20. For example, a valve may be used to isolate the electrochemical cell 10 from the Boudouard reactor 20.

The Boudouard reactor 20 can be disposed within a compartment of a negative electrode 18 of the electrochemical cell 10 or disposed separately from the electrochemical cell 10 and in fluid communication with the negative electrode 18. The Boudouard reactor 20 may be disposed in an interconnect 19, wherein the electrochemical cell 10 comprises a plurality of electrochemical cells that are connected via the interconnect 19. In an aspect, the Boudouard reactor 20 may be disposed in a separate compartment and in fluid communication with the electrochemical cell 10 via an interconnect 19.

The system may further comprise a gas store 30 in fluid communication with the electrochemical cell 10. The gas store 30 may comprise a movable barrier 34 separating the oxygen from the carbon-containing gas. Accordingly, in the gas store 30, the oxygen and the carbon-containing gas are separately stored. The carbon-containing gas may comprise CO and CO₂, or CO₂, depending on the mode (charge or discharge) and location, e.g., within the negative electrode 18 or within the Boudouard reactor 20. For example, the carbon-containing gas may comprise a mixture of carbon dioxide and carbon monoxide in a molar ratio of 100:0.01 to 100:0.1 moles of carbon dioxide to moles of carbon monoxide, 20:1 to 1:2, 1:1, 20:1 to 1:1, 10:1 to 1:1, 10:1 to 3:1, or the like.

The carbon store 30 can comprise a first compartment 33 and a second compartment 35, wherein the oxygen is stored in the first compartment 33 and the carbon-containing gas is stored in the second compartment 35. In an aspect, the first compartment 33 is in fluid communication with the positive electrode 11 of the electrochemical cell 10, and the second compartment is in fluid communication with the negative electrode 18 of the electrochemical cell 10. The first compartment 33 and the second compartment 35 can be configured to be pressure balanced, for example via the movable barrier 34. Examples of the movable barrier 34 include a movable piston, a diaphragm, an inflatable bladder, or a combination thereof. In an aspect, the barrier can be an elastic barrier, e.g., fixed to the gas store and expanding into the first compartment 33, the second compartment 35, or a combination thereof.

As a specific example, the gas store 30 comprises a first compartment 33 and a second compartment 35, wherein the oxygen is stored in the first compartment 33 and the carbon-containing gas is stored in the second compartment 35, and the movable barrier 34 is a flexible diaphragm that expands into the first compartment 33 or the second compartment 35.

The system 100 further comprises a fuel gauge (31, 32, 36, 22), which can provide a measure or an estimate of the energy remaining in the system. In an aspect, the fuel gauge may comprise a first fuel gauge and a second fuel gauge. The first fuel gauge may be configured to determine a state of charge based on a position of the movable barrier, a mass of the oxygen in the gas store, a volume of the oxygen in the gas store, a mass of the carbon-containing gas in the gas store, a volume of the carbon-containing gas in the gas store, or a combination thereof and the second fuel gauge may be configured to determine a mass of carbon in the carbon store, a volume of carbon in the carbon store, or a combination thereof.

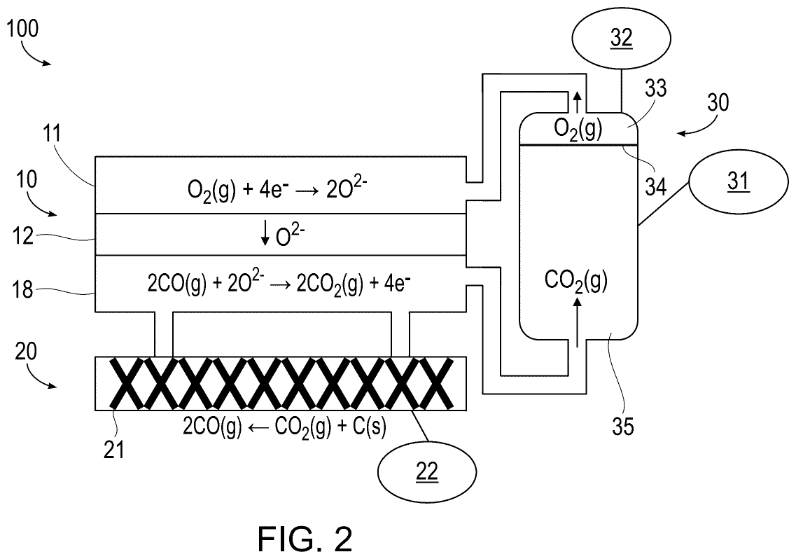

As shown in FIGS. 1 and 2, during discharge, the state of charge decreases as an amount (i.e., mass and volume) of the carbon-containing gas in the gas store 30 increases and as an amount (i.e., mass and volume) of carbon in the carbon store decreases and as an amount (i.e., mass and volume) of the oxygen in the gas store decreases. As the system is discharged, the movable barrier 34 moves position and decreases the volume of the first compartment 33 as the mass and the volume of the oxygen in the first compartment decreases and the mass and the volume of the carbon-containing gas increases. Conversely, as the system is charged, the state of charge increases in proportion to an amount (i.e., mass and volume) of the oxygen gas in the gas store 30 and to an amount (i.e., mass and volume) of carbon in the carbon store and in inverse proportion to an amount (i.e., mass and volume) of the carbon-containing gas in the gas store. As the system is charged, the movable barrier 34 moves position towards the second compartment 35 as the mass and the volume of the oxygen in the first compartment increases and the mass and the volume of the carbon-containing gas decreases. Accordingly, the state of charge of the system, during charge and discharge, may be determined on the basis of (i) the amount of the carbon-containing gas in the gas store, (ii) the amount of the oxygen in the gas store, (iii) the position of the movable barrier, and/or (iv) the amount of the carbon in the carbon store. The fuel gauge can include a carbon store fuel gauge 22 configured to sense a mass of carbon in the carbon store 21, a volume of carbon in the carbon store 21, or a combination thereof (also referred to herein as a “carbon sensor”).

The mass sensor can be a scale or a load cell. The volume of the carbon in the carbon store 21 may be measured by a gas or liquid displacement. In certain aspects, the volume of the carbon in the carbon store 21 may be estimated by a linear gauge, for example, the carbon store 21 can have a fixed area and additional material accumulates in the vertical direction, like a silo; in such an aspects, the volume of carbon may be estimated by measuring the height of the carbon in the carbon store 21. This height measurement may be accomplished using a laser gauge, an optical gauge, a dial gauge, a dilatometer, or other means of linear measurement known in the art. Measurement methods described above may be combined to provide redundancy and/or to improve overall measurement accuracy.

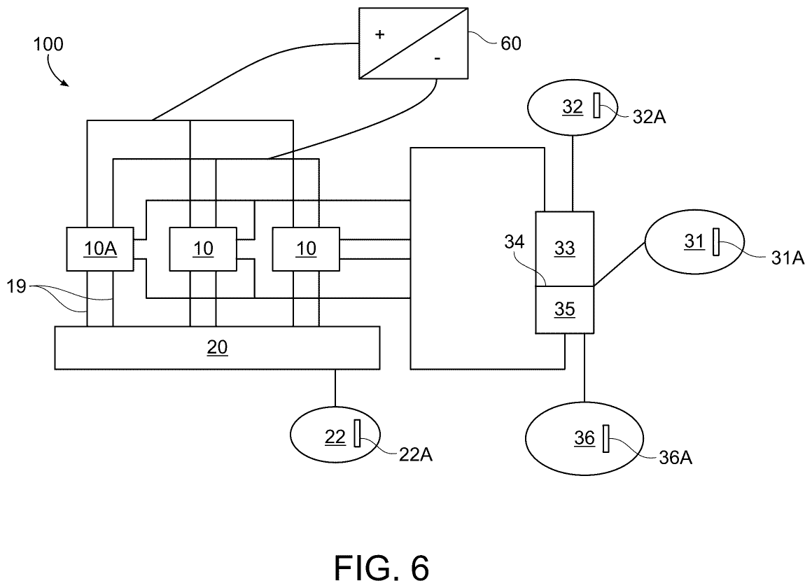

The system can also include a processor 22A configured to receive information relating to a mass of carbon in the carbon store 21, a volume of carbon in the carbon store 21, or a combination thereof, and to determine the state of charge based on the information (as shown in FIG. 6). The carbon store fuel gauge 22 may comprise a processor 22A, or the processor may be disposed outside of the carbon store fuel gauge 22.

The fuel gauge can include a gas store fuel gauge (31, 32, 36) that is configured to determine a state of charge based on a position of the movable barrier, a mass of oxygen in the gas store, a mass of a carbon-containing gas in the gas store, or a combination thereof. For example, the gas store fuel gauge 31 may be configured to determine a state of charge based on a position of the movable barrier, the gas store fuel gauge 32 may be configured to determine a state of charge based on a mass of the oxygen in the gas store, the gas store fuel gauge 36 may be configured to determine a state of charge based on a mass of the carbon-containing gas in the gas store, or a combination thereof.

The carbon-oxygen battery system can also comprise a processor (31A, 32A, 36A) configured to receive information relating to the position of the movable barrier, the mass of the oxygen in the gas store, the mass of the carbon-containing gas in the gas store, or a combination thereof, and to determine the state of charge based on the position of the movable barrier, the mass of the oxygen in the gas store, the mass of the carbon-containing gas in the gas store, or a combination thereof. The gas store fuel gauge (31, 32, and/or 36) may comprise a processor (31A, 32A, and 36A, respectively), or the processor (31A, 32A, and 36A) may be disposed outside of the gas store fuel gauge (31, 32, and/or 36).

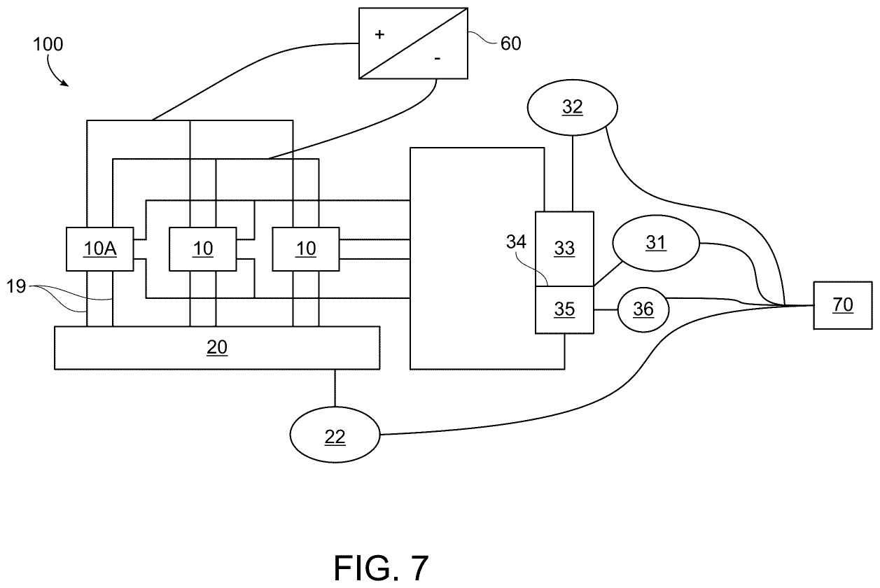

In an embodiment, one or more of the processors (22A, 31A, 32A, 36A) may be disposed outside of a fuel gauge. In an aspect, a central processor 70 may disposed outside of the fuel gauges and may serve as a processing unit for two or more fuel gauges. For example, the central processor 70 may serve as the processing unit for a carbon store fuel gauge 22 and gas store fuel gauges (31, 32, and 36) as shown in FIG. 7.

The system can comprise the carbon store fuel gauge 22, the gas store fuel gauge (31, 32, and/or 36), or a combination thereof. For example, the fuel gauge can combine measurements of the carbon store 20, the position of the movable barrier 34, and/or the mass of a gas in the gas store 30 to improve the accuracy of the fuel gauge estimation and/or to ensure redundancy in the event that one measurement fails or is compromised. In certain aspects, discrepancies in the measurements of the carbon store 20 and gas store 30 measurements may be used to signal that the system requires service or repair.

In a conventional active flow battery or a reversible fuel cell system, fluid communication between the stored electrochemical reactants and/or products and the power stack can be achieved through using pipes, tubes, manifolds, pumps, compressors, expanders, and/or recirculators. The pumps, recirculators, compressors, and related components are “active” components in the sense that they consume power in order to convey reactants and products to and from the power stack. This parasitic power consumption decreases the net output power from the system during discharge and increases the net input power required during charge, reducing the efficiency of the system, and increasing operating costs. These active components and the associated piping, tubing, etc. also add capital cost to the system without directly participating in electrochemical conversion reactions. As such, they are considered part of the balance of plant (BOP) of the system. BOP can be a significant capital cost driver, representing more than 60% of the total installed cost for certain systems. BOP components may also reduce the power and energy density of the system by taking up volume without directly contributing to power generation and energy conversion.

The carbon-oxygen battery system 100 of the disclosure can be configured to operate without a pump, a compressor, a blower, a condenser, or a combination thereof. The carbon-oxygen battery system 100 can be configured to generate an automatic gas flow between the electrochemical cell 10 and the gas store 20. Preferably, the gas store 30 and the electrochemical cell 10 form a closed system 40. In an aspect, the gas store and the electrochemical cell form a system having a constant volume. In another aspect, the gas store 30, the electrochemical cell 10, and the Boudouard reactor 20 form a closed system. As used herein, a “closed system” means that internal changes in pressure, temperature, and/or concentration occurring any place within the system may generate a gas flow within the closed system so that the components of the system are pressure balanced.

The carbon-oxygen battery system may include at least one removable electrochemical cell 10A (as shown in FIGS. 6 and 7) and may include multiple removable electrochemical cells. A plurality of electrochemical cells may be used in the form of an electrochemical cell stack, e.g., to provide a selected voltage, in which the electrochemical cells are interconnected to form a “stack”. The entire stack may be removable from the carbon-oxygen battery system. Also mentioned is a configuration in which the individual electrochemical cells of a stack are removable from the carbon-oxygen battery system.

In an aspect, the removable electrochemical cell, when present, can be configured to be selectively isolated from the carbon-oxygen battery system. Preferably, the removable electrochemical cell can be configured to be selectively isolated from the carbon-oxygen battery system and the gas store. In various aspects, it is possible to isolate the cell electrically, fluidically, mechanically, or thermally, and/or combinations and permutations thereof. In an aspect, each removable electrochemical cell can be configured to be independently isolated from the system. In another aspect, a grouping comprising a plurality of electrochemical cells can be isolated from the system; such a grouping can be advantageous because it reduces the cost of components and materials required to isolate electrochemical cells from the overall system. In certain aspects, the carbon-oxygen battery system can be configured to operate when one or more of the removable electrochemical cells is isolated from the system and at least one electrochemical cell is not isolated from the system. In certain aspects, the carbon-oxygen battery system may not be operable when removable electrochemical cells are isolated from the system.

The carbon-oxygen battery system 100 may comprise a plurality of Boudouard reactors. The plurality of Boudouard reactors may be independently isolated from the system 100. In an aspect, the plurality of Boudouard reactors may be in communication with one or more electrochemical cells. For example, the carbon-oxygen battery system 100 may comprise a plurality of electrochemical cells and each electrochemical cell may independently be in communication with a different Boudouard reactor. A plurality of Boudouard reactors may comprise a plurality of carbon stores and the plurality of carbon stores may be in independent communication with one or more carbon store fuel gauges 22.

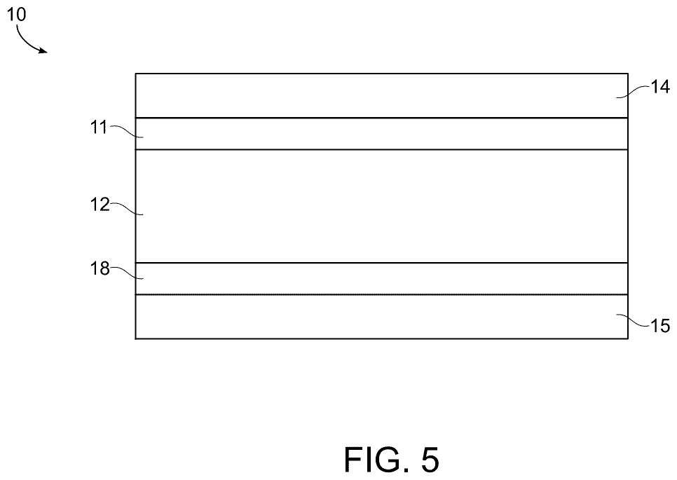

As shown in FIG. 5, in some embodiments, the electrochemical cell 10 may further include a positive interconnect 14 in contact with the positive electrode 11 and a negative interconnect 15 in contact with the negative electrode 18. The positive interconnect 14 and the negative interconnect 15 may be used to connect the positive electrodes and negative electrodes, respectively, between multiple electrochemical cells. In some embodiments, the interconnects (14, 15) may be current collectors for the respective electrodes.

The interconnects (14, 15) may be connected to an external circuit 60 for charging or discharging of the carbon-oxygen battery system 100. The interconnects (14, 15) may be connected to other electrical features by welding or soldering connections. In some embodiments, the interconnects (14, 15) may be connected to other electrical features by mechanical pressure fittings, which include bolted, spring loaded, or other suitable mechanical contacting terminals.

In some embodiments, the interconnects (14, 15) may have surfaces that are coated with an oxidation resistant coating. The oxidation resistant coating can include nickel (Ni), nickel-alloys, chrome (Cr), chrome-alloys, gold (Au), and/or other oxidation resistant, conductive materials. The electrical interfaces can be coated with a joint compound. The joint compounds can be a liquid or gel component that covers the exposed metallic surface to prevent corrosion and/or passivation.

The positive electrode 11 of the electrochemical cell 10 may be any suitable oxygen electrode. Exemplary positive electrode materials include lanthanum strontium cobalt ferrite (LSCF), strontium-doped lanthanum manganate, strontium oxide and bismuth oxide doped with lanthanum manganate, lanthanum strontium cobaltite (LSC), barium strontium iron cobaltite (BSCF), strontium doped hafnium oxide, europium cobaltite (EC), or the like, or a combination thereof. In some embodiments, the positive electrode may include lanthanum strontium cobalt ferrite (LSCF). In other embodiments, the positive electrode may include Bi₂O₃-MO (wherein M is one or more of Ca, Sr, Ba, or Cu), Bi₂O₃-MO₂ (wherein M is one or more of Ti, Zr, or Te), Bi₂O₃-MO₃ (wherein M is one or more of W or Mo), Bi₂O₃-M₂O₅ (wherein M is one or more of V, Nb, or Ta), Bi₂O₃-M₂O₃ (wherein M is one or more of La, Sm, Y, Gd, or Er), nickel, a lithiated nickel oxide, or a combination thereof. Preferably, the positive electrode is porous such that it is permeable for diffusing gaseous electrochemical reactants (e.g., oxygen).

The negative electrode 18 of the electrochemical cell 10 may comprise any suitable negative electrode material. The negative electrode 18 may include an electron-conducting material and ceria doped with one or more rare earth elements such as Gd, Sm, Pr, La, Y, or Yb, and/or one or more other elements such as Mn or Fe. The electron-conducting material may include ceramic oxides such as Sr-doped lanthanum chromite, Nb-, La-, or Y-doped strontium titanate, strontium iron molybdate, or the like, or a combination thereof, and/or metals such as copper, silver, or the like, or a combination thereof. Exemplary negative electrode materials include nickel oxide (NiO), cerium oxide (CeO₂), copper oxide (CuO), strontium titanate (SrTiO₃), yttrium oxide doped strontium titanate (YST), thorium oxide doped strontium titanate (TSST), or the like, or a combination thereof. Other exemplary negative electrode materials may include ceramic oxides such as lanthanum strontium chromite, strontium iron molybdate, copper, silver, or the like, or a combination thereof. Preferably, the negative electrode is porous such that it is permeable for diffusing gaseous electrochemical reaction reactants (e.g., CO₂).

The electrolyte 12 is disposed between the positive electrode 11 and the negative electrode 18. Any suitable electrolyte material, or combination of materials, may be used. In some embodiments, the electrolyte may include a solid oxide electrolyte or a molten salt electrolyte such as a molten carbonate electrolyte, a molten hydroxide electrolyte, or a combination thereof.

Examples of solid oxide electrolytes include yttrium oxide stabilized zirconia (YSZ), strontium stabilized zirconia, gadolinium oxide stabilized zirconia (GSZ), gadolinium oxide doped cerium oxide, hafnium oxide doped cerium oxide (GDC), hafnium oxide doped cerium oxide (SDC), strontium and magnesium doped lanthanum gallate (LSGM), yttrium oxide doped cerium oxide (YDC), strontium oxide, magnesium oxide, Li₂₊₂ₓZn₁₋ₓGeO₄, Li-β-alumina, lithium phosphorus oxynitride (LiPON), Li_{1.3}Al_{0.3}Ti_{1.7} (PO₄)₃, LaGaO₃-containing oxides, Sr(Ce,Yb)O₃-containing oxides, BaCeO₃-containing oxides, perovskite oxides, (Ba,La,Sr)₂In₂O₅-containing oxides, LaCeMgO₃-containing oxides, or the like, or a combination thereof.

Examples of the molten carbonate electrolytes include Li—K molten carbonate electrolyte, Li—Na molten carbonate electrolyte, Li—K—Na molten carbonate electrolyte, or the like, or a combination thereof.

Examples of the molten hydroxide electrolytes include molten sodium hydroxide electrolyte, molten potassium hydroxide electrolyte, or a combination thereof.

In an aspect, the electrochemical cell 10 may include a multilayered electrolyte including a first layer and a second layer, wherein the first layer and the second layer are different from each other. For example, the first layer may include a first electrolyte including a first solid oxygen conductor, and the second layer may include a second electrolyte including a second solid oxygen conductor electrolyte different from the first solid oxygen ion conductor in chemical composition, form, or both.

Additional details of the electrochemical cell can be determined by one of skill in the art without undue experimentation, and are also available in The Handbook of Fuel Cells—Fundamentals, Technology, and Applications, W. Vielstich, H. A. Gasteiger, and A. Lamm, Eds., 2010, the content of which is incorporated herein by reference in its entirety, for example.

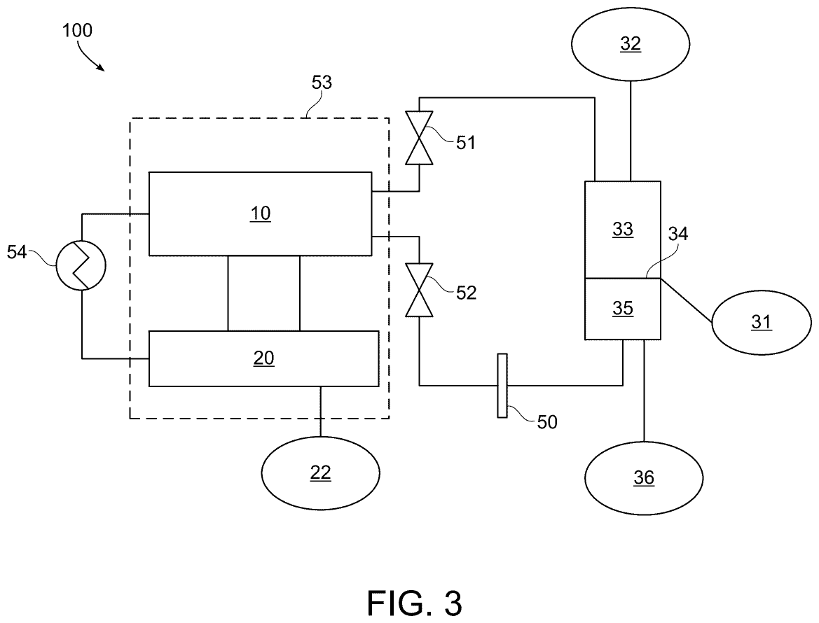

The carbon-oxygen battery system 100 can further comprise a thermal chamber 53 (as shown in FIGS. 3 and 4). For example, the Boudouard reactor 20, the electrochemical cell 10, or both can be disposed in a thermal chamber. In an aspect, the Boudouard reactor 20 is disposed in a first thermal chamber and the electrochemical cell 10 is disposed in a second thermal chamber. In an aspect, the stack including a plurality of removable electrochemical cells may be disposed within a thermal chamber. In an aspect, Boudouard reactor 20 may be disposed in a thermal chamber, which may be the same thermal chamber as the electrochemical cell 10, but embodiments are not limited thereto, and the Boudouard reactor 20 may also be disposed in a separate thermal chamber from the electrochemical cell 10.

In an aspect, a plurality of thermal chambers may be used. For example, in an aspect the carbon-oxygen battery system 100 can comprise a plurality of electrochemical cells and can further comprise a plurality of thermal chambers. In an aspect, the Boudouard reactor 20 can be disposed in a first thermal chamber of the plurality of thermal chambers. At least one electrochemical cell of the plurality of electrochemical cells can be disposed in a second thermal chamber of the plurality of thermal chambers.

Any suitable thermal chamber may be used. The thermal chamber may be configured to provide a desired operating temperature for the removable electrochemical cell, the Boudouard reactor, or both. By using separate thermal chambers for the electrochemical cell (or stack thereof) and the Boudouard reactor, it may be possible to deactivate the heating function to selective parts of the carbon-oxygen battery system when replacing a removable electrochemical cell (or stack thereof), without disturbing the heating function in the other removable electrochemical cells.

The thermal chamber may be configured to provide and maintain any desirable temperature. In an aspect, the thermal chamber may be configured to provide an operating temperature that is greater than 400° C., greater than 500° C., greater than 700° C., or greater than 1000° C. For example, the thermal chamber may maintain a temperature of 400° C. to 1500° C., or 500° C. to 1000° C.

The carbon-oxygen battery system 100 can further comprise a heat exchanger 54 (as shown in FIGS. 3 and 4). Without wishing to be bound by theory, it is believed that the presence of the heat exchanger can increase the efficiency of the carbon-oxygen battery system 100 by exchanging heat between the Boudouard reactor 20 and the electrochemical cell 10. Thus, when present, the heat exchanger can be configured to exchange heat between the Boudouard reactor 20 and the electrochemical cell 10. In an aspect, the carbon-oxygen battery system 100 can further comprise a heat exchanger which can be in contact with the carbon store 21. For example, the heat exchanger can be in thermal contact with the carbon store 21.

The carbon-oxygen battery system can further comprise a carbon dioxide separation membrane 50 configured to separate carbon dioxide from the carbon-containing gas. The carbon dioxide separation membrane 50 is disposed between the gas store 30 and the electrochemical cell 10, for example, between the second compartment 35 of the gas store 30 and the negative electrode 18 of the electrochemical cell 10.

As shown in FIG. 3, the carbon-oxygen battery system can further comprise: a first valve 51 disposed between the gas store 30 and the electrochemical cell 10, wherein the first valve 51 is configured to control a flow of the oxygen; and a second valve 52 disposed between the gas store 30 and the electrochemical cell 10, wherein the second valve 52 is configured to control a flow of the carbon-containing gas. The valves (51, 52) may be configured to maintain, monitor, and adjust the flow of the oxygen or the carbon-containing gas from the electrochemical cell to the gas store, from the gas store to the electrochemical cell, or a combination thereof. The valves (51, 52) can also be configured to determine an amount of the oxygen or the carbon-containing gas on the basis of the metered amount of the oxygen or the carbon-containing gas passing through the valves to determine a state of charge of the system.

The carbon-oxygen battery system 100 is configured to be charged by supplying electricity and carbon dioxide gas to the battery, and discharged by converting elemental carbon in its solid form to carbon dioxide gas, thereby generating electricity. It is to be understood that the Boudouard reactor 20 is configured to reversibly precipitate solid carbon from carbon-monoxide gas (2 CO→C+CO₂) and to gasify solid carbon into carbon monoxide (C+CO₂->2CO), and thus serve as both a source for elemental carbon and as storage for elemental carbon that is produced. It is to be further understood that in some aspects, a separate carbon store (e.g., a source of carbon) can be included in which the carbon store can be configured to reversibly store solid carbon, and thus serve as both a source for elemental carbon and as storage for elemental carbon that is produced. It is to be further understood that the gas store 30 is configured to reversibly store carbon dioxide and oxygen, and thus serves as both a source for carbon dioxide and oxygen and as storage for carbon dioxide and oxygen that is produced. Carbon monoxide generated in the gasification reaction during charge (equation 1) or during the Boudouard reaction during discharge (equation 2) may also be present in the gas store. The carbon monoxide is an intermediate reactant and may be present as a contaminant in the carbon dioxide stream. The amount of carbon monoxide present in the carbon-containing gas may vary depending on the temperature, pressure, and/or operating conditions of the system.

A method of operating a carbon-oxygen battery system includes providing a carbon-oxygen battery system as described herein, supplying electricity and a carbon-containing gas flow to the carbon-oxygen battery to charge the battery system, and discharging the carbon-oxygen battery system to convert the carbon to the carbon-containing gas and produce electricity. The method can further comprise determining the state of charge of the carbon-oxygen battery system using the fuel gauge.

During charging, the carbon-containing gas is provided by the gas store 30, the carbon-containing gas comprises carbon dioxide and the carbon dioxide is converted to carbon monoxide and oxygen by the electrochemical cell 10, the carbon monoxide from the electrochemical cell 10 is converted to carbon dioxide and carbon in the Boudouard reactor 20. The carbon produced by charging is stored in the carbon store 21. The charging further comprises movement of the movable barrier 34 driven by a volume change of the carbon-containing gas and a volume change of the oxygen in the gas store 30, as the barrier passively moves to a configuration having a greater volume of oxygen in the gas store 30.

During discharge, the carbon and carbon dioxide are converted in the Boudouard reactor 20 to carbon monoxide, the carbon monoxide and oxygen are converted to carbon dioxide by the electrochemical cell 10, and the carbon dioxide produced by discharge is stored in the gas store 30. The discharge further comprises movement of the movable barrier 34 passively to a configuration having a greater volume of carbon dioxide (i.e., carbon-containing gas) in the gas store 30. In an aspect, the gas store may comprise an inflatable bladder and the moveable barrier may comprise a surface of the inflatable bladder, where the oxygen fills the inflatable bladder on charge or the carbon-containing gas fills the inflatable bladder on discharge. In an aspect, the movable barrier is not actively moved during charge or discharge of the system.

This disclosure further encompasses the following aspects.

Aspect 1: A carbon-oxygen battery system, comprising: a Boudouard reactor in fluid communication with an electrochemical cell; a carbon store configured to store carbon; a gas store in fluid communication with the electrochemical cell, the gas store configured to separately store oxygen and a carbon-containing gas, wherein the gas store comprises a movable barrier separating the oxygen from the carbon-containing gas; and a fuel gauge configured to determine a state of charge based on a position of the movable barrier, a mass of the oxygen in the gas store, a mass of the carbon-containing gas in the gas store, a mass of carbon in the carbon store, a volume of carbon in the carbon store, or a combination thereof, wherein the gas store and the electrochemical cell form a closed system.

Aspect 2A: The carbon-oxygen battery system of aspect 1, wherein the carbon-oxygen battery system is configured to generate an automatic gas flow between the electrochemical cell and the gas store.

Aspect 2B: The carbon-oxygen battery system of aspect 1, wherein the carbon-oxygen battery system is configured to provide an oxygen flow from the gas store to the electrochemical cell and to provide a carbon-containing gas flow to the gas store from the electrochemical cell during discharge. The carbon-oxygen battery system is configured to provide the oxygen flow to the gas store from the electrochemical cell and to provide the carbon-containing gas flow from the gas store to the electrochemical cell during charge.

Aspect 3: The carbon-oxygen battery system of aspect 1 or 2, wherein the oxygen and the carbon-containing gas in the gas store are configured to be pressure balanced.

Aspect 4: The carbon-oxygen battery system of any of aspects 1 to 3, wherein the carbon store is disposed inside the Boudouard reactor, or wherein the carbon store is disposed outside of the Boudouard reactor and in fluid communication with the Boudouard reactor, wherein the gas store comprises a first compartment and a second compartment, wherein the oxygen is stored in the first compartment and the carbon-containing gas is stored in the second compartment.

Aspect 5: The carbon-oxygen battery system of aspect 4, wherein the first compartment and the second compartment are configured to be pressure balanced.

Aspect 6: The carbon-oxygen battery system of aspect 4, wherein the movable barrier is configured to maintain a same pressure in the first compartment and the second compartment.

Aspect 7: The carbon-oxygen battery system of any of aspects 1 to 6, wherein the movable barrier comprises a movable piston, a diaphragm, an inflatable bladder, or a combination thereof.

Aspect 8: The carbon-oxygen battery system of aspect 7, wherein the gas store comprises a first compartment and a second compartment, wherein the oxygen is stored in the first compartment and the carbon-containing gas is stored in the second compartment, and wherein the movable barrier is a flexible diaphragm that expands into the first compartment or the second compartment.

Aspect 9: The carbon-oxygen battery system of any of aspects 1 to 8, further comprising a carbon store fuel gauge configured to sense a mass of carbon in the carbon store, a volume of carbon in the carbon store, or a combination thereof.

Aspect 10: The carbon-oxygen battery system of any of aspects 1 to 9, wherein the carbon-containing gas comprises carbon monoxide and carbon dioxide.

Aspect 11: The carbon-oxygen battery system of aspect 10, further comprising a carbon dioxide separation membrane configured to separate carbon dioxide from the carbon-containing gas.

Aspect 12: The carbon-oxygen battery system of aspect 11, wherein the carbon dioxide separation membrane is disposed between the gas store and the electrochemical cell.

Aspect 13: The carbon-oxygen battery system of any of aspects 1 to 12, wherein the carbon-oxygen battery system is configured to operate without a pump, a compressor, a blower, a condenser, or a combination thereof.

Aspect 14: The carbon-oxygen battery system of any of aspects 1 to 13, further comprising: a first valve disposed between the gas store and the electrochemical cell, wherein the first valve is configured to control a flow of the oxygen; and a second valve disposed between the gas store and the electrochemical cell, wherein the second valve is configured to control a carbon-containing gas flow.

Aspect 15: The carbon-oxygen battery system of any of aspects 1 to 14, wherein the electrochemical cell comprises a positive electrode, a negative electrode, and an electrolyte disposed between the positive electrode and the negative electrode, wherein the electrolyte comprises a solid oxide electrolyte, a molten salt electrolyte, preferably a molten carbonate electrolyte, a molten hydroxide electrolyte, or a combination thereof.

Aspect 16: The carbon-oxygen battery system of any of aspects 1 to 15, further comprising a heat exchanger configured to exchange heat between the Boudouard reactor and the electrochemical cell.

Aspect 17: The carbon-oxygen battery system of any of aspects 1 to 16, wherein at least one of the Boudouard reactor and the electrochemical cell are disposed in a thermal chamber.

Aspect 18: The carbon-oxygen battery system of any of aspects 1 to 17, wherein the electrochemical cell comprises a plurality of electrochemical cells, wherein each electrochemical cell of the plurality of electrochemical cells is in electrical contact with an external circuit.

Aspect 19: The carbon-oxygen battery system of aspect 18, wherein at least one electrochemical cell of the plurality of electrochemical cells is a removable electrochemical cell.

Aspect 20: The carbon-oxygen battery system of aspect 19, wherein the at least one removable electrochemical cell is configured to be selectively isolated from the carbon-oxygen battery system.

Aspect 21: The carbon-oxygen battery system of aspect 19 or 20, wherein the at least one removable electrochemical cell is configured to be selectively isolated from the gas store.

Aspect 22: The carbon-oxygen battery system of any of aspects 19 to 21, wherein the carbon-oxygen battery system is configured to operate when the at least one removable electrochemical cell is isolated from the system and at least one electrochemical cell is not isolated from the system.

Aspect 23: The carbon-oxygen battery system of any of aspects 1 to 22, further comprising a processor configured to receive information relating to the position of the movable barrier, the mass of the oxygen in the gas store, the mass of the carbon-containing gas in the gas store, the mass of carbon in the carbon store, the volume of carbon in the carbon store, or a combination thereof, and to determine the state of charge based on the position of the movable barrier, the mass of the oxygen in the gas store, the mass of the carbon-containing gas in the gas store, the mass of carbon in the carbon store, the volume of carbon in the carbon store, or a combination thereof.

Aspect 24: The carbon-oxygen battery system of any of aspects 1 to 23, wherein the Boudouard reactor is: disposed within a compartment of a negative electrode of the electrochemical cell; disposed in a separate reactor from the electrochemical cell; or disposed in a separate reactor that forms an interconnect, wherein the electrochemical cell comprises a plurality of electrochemical cells that are connected via the interconnect.

Aspect 25: The carbon-oxygen battery system of any of aspects 1 to 24, further comprising a plurality of Boudouard reactors.

Aspect 26: The carbon-oxygen battery system of any of aspects 1 to 25, wherein the fuel gauge comprises a first fuel gauge and a second fuel gauge, wherein the first fuel gauge is configured to determine a state of charge based on a position of the movable barrier, a mass of the oxygen in the gas store, a mass of the carbon-containing gas in the gas store, or a combination thereof and the second fuel gauge is configured to determine a mass of carbon in the carbon store, a volume of carbon in the carbon store, or a combination thereof.

Aspect 27: The carbon-oxygen battery system of any of aspects 1 to 26, wherein the gas store, the electrochemical cell, and the Boudouard reactor form a closed system.

Aspect 28. A battery fuel gauge configured to determine a state of charge of a carbon-oxygen battery, wherein the battery fuel gauge comprises a processor configured to receive information relating to a position of a movable barrier of a gas store, a mass of oxygen in the gas store, a mass of a carbon-containing gas in the gas store, or a combination thereof and to determine the state of charge based on the position of the movable barrier, the mass of the oxygen in the gas store, the mass of the carbon-containing gas in the gas store, or a combination thereof; wherein the carbon-oxygen battery comprises an electrochemical cell, a carbon store, a Boudouard reactor in fluid communication with the electrochemical cell and the carbon store, and the gas store; and the gas store is configured to separately store the oxygen and the carbon-containing gas, wherein the gas store comprises the movable barrier separating the oxygen from the carbon-containing gas, wherein the gas store and the electrochemical cell form a closed system.

Aspect 29: A battery fuel gauge configured to determine a state of charge of a carbon-oxygen battery, wherein the battery fuel gauge comprises a processor configured to receive information relating to a mass of carbon in a carbon store, a volume of carbon in the carbon store, or a combination thereof and to determine the state of charge based on the mass of carbon in the carbon store, the volume of carbon in the carbon store, or a combination thereof; wherein the carbon-oxygen battery comprises: an electrochemical cell, a carbon store, and a Boudouard reactor in fluid communication with the electrochemical cell and the carbon store.

Aspect 30: A method of operating a carbon-oxygen battery system, the method comprising: providing a carbon-oxygen battery system of any of aspects 1 to 27; charging the carbon-oxygen battery system by supplying electricity to the carbon-oxygen battery system, supplying a carbon-containing gas flow to the electrochemical cell, wherein the carbon-containing gas flow comprises carbon dioxide and is provided by the gas store, converting the carbon dioxide to carbon monoxide and oxygen in the electrochemical cell, converting the carbon monoxide to carbon dioxide and carbon in the Boudouard reactor, storing the carbon produced by the charging in the carbon store, and storing the oxygen produced by charging in the gas store; and discharging the carbon-oxygen battery system to produce electricity by converting the carbon and carbon dioxide in the Boudouard reactor to carbon monoxide, supplying an oxygen gas flow to the electrochemical cell, wherein the oxygen gas flow is provided by the gas store, converting the carbon monoxide and oxygen to carbon dioxide by the electrochemical cell, and storing the carbon dioxide produced by the discharging in the gas store.

Aspect 31: The method of aspect 30, further comprising determining the state of charge of the carbon-oxygen battery system using the fuel gauge.

Aspect 32: The method of aspect 30 or 31, wherein the charging further comprises passive movement of the movable barrier to a configuration having a greater volume of oxygen in the gas store.

Aspect 33: The method of any of aspects 30 to 32, wherein the discharging further comprises passive movement of the movable barrier to a configuration having a greater volume of the carbon-containing gas in the gas store.

Aspect 34: The method of any of aspects 30 to 32, wherein the gas store comprises an inflatable bladder, and the movable barrier is formed from a surface of the inflatable bladder, wherein the oxygen fills the inflatable bladder on charge or the carbon-containing gas fills the inflatable bladder on discharge.

Aspect 35: The method of any of aspects 30 to 34, wherein the gas store comprises a single inflatable bladder, wherein the oxygen is contained in the inflatable bladder, wherein oxygen is added to the inflatable bladder on charge.

Aspect 36: The method of any of aspects 30 to 34, wherein the gas store comprises a single inflatable bladder, wherein the carbon-containing gas is contained in the inflatable bladder, wherein the carbon-containing gas is added to the inflatable bladder on discharge.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, which are otherwise not necessary to the achievement of the function or objectives of the compositions, methods, and articles.

All ranges disclosed herein are inclusive of the endpoints, and the endpoints are independently combinable with each other (e.g., ranges of “up to 25 wt %, or, more specifically. 5 wt % to 20 wt %”, is inclusive of the endpoints and all intermediate values of the ranges of “5 wt % to 25 wt %.” etc.). “Combinations” is inclusive of blends, mixtures, alloys, reaction products, and the like. The terms “first.” “second.” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments.” “an embodiment.” “an aspect,” and so forth, means that a particular element described in connection with the embodiment and/or aspect is included in at least one embodiment and/or aspect described herein, and may or may not be present in other embodiments and/or aspects. In addition, it is to be understood that the described elements may be combined in any suitable manner in the various embodiments and/or aspects. A “combination thereof” is open and includes any combination comprising at least one of the listed components or properties optionally together with a like or equivalent component or property not listed.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A carbon-oxygen battery system, comprising:
a Boudouard reactor in fluid communication with an electrochemical cell;
a carbon store configured to store carbon;
a gas store in fluid communication with the electrochemical cell, the gas store configured to separately store oxygen and a carbon-containing gas, wherein the gas store comprises a movable barrier separating the oxygen from the carbon-containing gas; and
a fuel gauge configured to determine a state of charge based on a position of the movable barrier, a mass of the oxygen in the gas store, a mass of the carbon-containing gas in the gas store, a mass of carbon in the carbon store, a volume of carbon in the carbon store, or a combination thereof,
wherein the gas store and the electrochemical cell form a closed system.

2. The carbon-oxygen battery system of claim 1, wherein the carbon-oxygen battery system is configured to provide an oxygen flow from the gas store to the electrochemical cell and to provide a carbon-containing gas flow to the gas store from the electrochemical cell during discharge; and
wherein the carbon-oxygen battery system is configured to provide the oxygen flow to the gas store from the electrochemical cell and to provide the carbon-containing gas flow from the gas store to the electrochemical cell during charge.

3. The carbon-oxygen battery system of claim 1, wherein the oxygen and the carbon-containing gas in the gas store are configured to be pressure balanced;
wherein the movable barrier comprises a movable piston, a diaphragm, an inflatable bladder, or a combination thereof;
further comprising a carbon store fuel gauge configured to sense a mass of carbon in the carbon store, a volume of carbon in the carbon store, or a combination thereof;
wherein the carbon-containing gas comprises carbon monoxide and carbon dioxide;
wherein the carbon-oxygen battery system is configured to operate without a pump, a compressor, a blower, a condenser, or a combination thereof; or
a combination thereof.

4. The carbon-oxygen battery system of claim 1, wherein the carbon store is disposed inside the Boudouard reactor, or wherein the carbon store is disposed outside of the Boudouard reactor and in fluid communication with the Boudouard reactor,
wherein the gas store comprises a first compartment and a second compartment, wherein the oxygen is stored in the first compartment and the carbon-containing gas is stored in the second compartment.

5. The carbon-oxygen battery system of claim 4, wherein the first compartment and the second compartment are configured to be pressure balanced;
wherein the movable barrier is configured to maintain a same pressure in the first compartment and the second compartment; or
a combination thereof.

6. The carbon-oxygen battery system of claim 3, further comprising a carbon dioxide separation membrane configured to separate carbon dioxide from the carbon-containing gas.

7. The carbon-oxygen battery system of claim 6, wherein the carbon dioxide separation membrane is disposed between the gas store and the electrochemical cell.

8. The carbon-oxygen battery system of claim 1, further comprising:
a first valve disposed between the gas store and the electrochemical cell, wherein the first valve is configured to control a flow of the oxygen; and
a second valve disposed between the gas store and the electrochemical cell, wherein the second valve is configured to control a carbon-containing gas flow.

9. The carbon-oxygen battery system of claim 1, wherein the electrochemical cell comprises a positive electrode, a negative electrode, and an electrolyte disposed between the positive electrode and the negative electrode, wherein the electrolyte comprises a solid oxide electrolyte, a molten salt electrolyte, a molten hydroxide electrolyte, or a combination thereof.

10. The carbon-oxygen battery system of claim 1, further comprising a heat exchanger configured to exchange heat between the Boudouard reactor and the electrochemical cell;
wherein at least one of the Boudouard reactor and the electrochemical cell are disposed in a thermal chamber;
wherein the electrochemical cell comprises a plurality of electrochemical cells, wherein each electrochemical cell of the plurality of electrochemical cells is in electrical contact with an external circuit; or
a combination thereof.

11. The carbon-oxygen battery system of claim 10, wherein at least one electrochemical cell of the plurality of electrochemical cells is a removable electrochemical cell.

12. The carbon-oxygen battery system of claim 11, wherein the at least one removable electrochemical cell is configured to be selectively isolated from the carbon-oxygen battery system;
wherein the at least one removable electrochemical cell is configured to be selectively isolated from the gas store;
wherein the carbon-oxygen battery system is configured to operate when the at least one removable electrochemical cell is isolated from the system and at least one electrochemical cell is not isolated from the system; or
a combination thereof.

13. The carbon-oxygen battery system of claim 1, further comprising a processor configured to receive information relating to the position of the movable barrier, the mass of the oxygen in the gas store, the mass of the carbon-containing gas in the gas store, the mass of carbon in the carbon store, the volume of carbon in the carbon store, or a combination thereof, and to determine the state of charge based on the position of the movable barrier, the mass of the oxygen in the gas store, the mass of the carbon-containing gas in the gas store, the mass of carbon in the carbon store, the volume of carbon in the carbon store, or a combination thereof.

14. The carbon-oxygen battery system of claim 1, wherein the Boudouard reactor is:
disposed within a compartment of a negative electrode of the electrochemical cell;
disposed in a separate reactor from the electrochemical cell; or
disposed in a separate reactor that forms an interconnect, wherein the electrochemical cell comprises a plurality of electrochemical cells that are connected via the interconnect.

15. The carbon-oxygen battery system of claim 1, further comprising a plurality of Boudouard reactors.

16. The carbon-oxygen battery system of claim 1, wherein the fuel gauge comprises a first fuel gauge and a second fuel gauge,
wherein the first fuel gauge is configured to determine a state of charge based on a position of the movable barrier, a mass of the oxygen in the gas store, a mass of the carbon-containing gas in the gas store, or a combination thereof and the second fuel gauge is configured to determine a mass of carbon in the carbon store, a volume of carbon in the carbon store, or a combination thereof.

17. The carbon-oxygen battery system of claim 1, wherein the gas store, the electrochemical cell, and the Boudouard reactor form a closed system.

18. A battery fuel gauge configured to determine a state of charge of a carbon-oxygen battery,
wherein the battery fuel gauge comprises a processor configured to receive information relating to a position of a movable barrier of a gas store, a mass of oxygen in the gas store, a mass of a carbon-containing gas in the gas store, or a combination thereof and to determine the state of charge based on the position of the movable barrier, the mass of the oxygen in the gas store, the mass of the carbon-containing gas in the gas store, or a combination thereof;
wherein the carbon-oxygen battery comprises:
an electrochemical cell, a carbon store, a Boudouard reactor in fluid communication with the electrochemical cell and the carbon store, and the gas store,
wherein the gas store is configured to separately store the oxygen and the carbon-containing gas, wherein the gas store comprises the movable barrier separating the oxygen from the carbon-containing gas,
wherein the gas store and the electrochemical cell form a closed system.

19. A method of operating a carbon-oxygen battery system, the method comprising:
providing the carbon-oxygen battery system of claim 1;
charging the carbon-oxygen battery system by
supplying electricity to the carbon-oxygen battery system,
supplying a carbon-containing gas flow to the electrochemical cell, wherein the carbon-containing gas flow is provided by the gas store,
converting the carbon dioxide to carbon monoxide and oxygen in the electrochemical cell,
converting the carbon monoxide to carbon dioxide and carbon in the Boudouard reactor,
storing the carbon produced by the charging in the carbon store, and
storing the oxygen produced by charging in the gas store; and
discharging the carbon-oxygen battery system to produce electricity by
converting the carbon and carbon dioxide in the Boudouard reactor to carbon monoxide,
supplying an oxygen gas flow to the electrochemical cell, wherein the oxygen gas flow is provided by the gas store,
converting the carbon monoxide and oxygen to carbon dioxide by the electrochemical cell, and
storing the carbon dioxide produced by the discharging in the gas store.

20. The method of claim 19, further comprising determining the state of charge of the carbon-oxygen battery system using the fuel gauge;
wherein the charging further comprises passive movement of the movable barrier to a configuration having a greater volume of oxygen in the gas store or wherein the discharging further comprises passive movement of the movable barrier to a configuration having a greater volume of the carbon-containing gas in the gas store;
wherein the gas store comprises an inflatable bladder, and the movable barrier is formed from a surface of the inflatable bladder, wherein the oxygen fills the inflatable bladder on charge or the carbon-containing gas fills the inflatable bladder on discharge;
wherein the gas store comprises a single inflatable bladder, wherein (i) the oxygen is contained in the inflatable bladder, wherein oxygen is added to the inflatable bladder on charge or wherein (ii) the carbon-containing gas is contained in the inflatable bladder, wherein the carbon-containing gas is added to the inflatable bladder on discharge; or
a combination thereof.
